(19) United States
(12) Patent Application Publication
(10) Pub. No.: US 2002/0131187 A1
(43) Pub. Date: Sep. 19, 2002

(54) Evaluation system for magnetic disk medium

(76) Inventor: Shigeru Komine, Nagano (JP)

Correspondence Address: ROSSI & ASSOCIATES, P. O. Box 826, Ashburn, VA, 20146-0826, US

(21) Appl. No.: 10/099,871

(22) Filed: Mar. 14, 2002

(30) Foreign Application Priority Data
Mar. 14, 2001 (JP) 2001-072090

(51) Int. Cl. G11B 27/36; G11B 5/596

(52) U.S. Cl. 360/31; 360/77.02

(57) ABSTRACT

An evaluation system for magnetic disk medium for accurately measures and evaluates read/write characteristics and off-track characteristics for a magnetic disk of a discrete track system via an evaluation system that does not comprise a tracking servo control function. Measurements are taken independently of a mechanism portion by only improving the signal processing portion of an evaluation system, which does not have a tracking servo control function. A read signal from a magnetic head is amplified, and subjected to analog/digital conversion and stored. Simultaneously, the timing at which the head is in the proximity of the center of a track and/or the timing out of a servo pattern area are detected from a read signal. Using this timing data, only a portion of the read signal which is suitable for evaluation is selected and extracted from stored data, and the measuring and evaluation of read/write characteristics are implemented.

### FIELD OF THE INVENTION

The present invention is related to an evaluation system for a magnetic disk medium, and more particularly to an evaluation system for evaluating the read/write characteristics of a discrete track magnetic disk medium, on which is formed isolation grooves between tracks to enhance track density.

### BACKGROUND OF THE INVENTION

One method for evaluating the characteristics of a magnetic disk recording medium (hereinafter referred to simply as a magnetic disk) makes use of an actual magnetic head utilized in a magnetic disk recording device such as a Hard Disk Drive (HDD) or a magnetic head equivalent thereto, and is performed by writing a signal to a magnetic disk, thereafter reading out this signal (hereinafter referred to as reading), and measuring and evaluating various read/write characteristics according to this read signal. These characteristics for evaluation are, for example, track average amplitude (TAA) characteristics, which indicate the size of an average amplitude of one rotation's worth of read signals, waveform characteristics for Pulse Width at 50% Threshold (PW50), which indicates the sharpness of a signal waveform, and SN ratio (signal-to-noise ratio) characteristics, which indicate the ratio of a signal to noise.

FIG. 3 shows a simplified block diagram of the signal processing portion of a conventional magnetic disk evaluation system. In this figure, 1 is a magnetic head for writing and reading a signal to and from a magnetic disk not shown in the figure; 2 is a preamplifier for amplifying either a write signal to this magnetic head 1 or a read signal from the magnetic head 1; 3 is a write circuit for sending a write signal to the magnetic head; 4 is a read amplifier for amplifying a read signal acquired from the magnetic head via preamplifier 2; and 5 is a measuring circuit for measuring and evaluating a read signal outputted from read amplifier 4. Other components of an evaluation system not shown in the figure are a disk drive portion, comprising a spindle motor for chucking (fastening) a magnetic disk and driving it in a rotating direction, and a magnetic head drive portion comprising a motor for moving a magnetic head to an arbitrary position and performing either a read or write operation to the surface of a magnetic disk.

An evaluation is carried out via the following procedure. First, the magnetic head is affixed at a certain radial position above the surface of a magnetic disk. A write signal is generated from write circuit 3. Data write is performed on the magnetic disk by applying a current to magnetic head 1, which amplifies this signal via preamplifier 2. Next, the data written to this magnetic disk is read by magnetic head 1. Continuous analog waveform read signals from magnetic head 1 are amplified by preamplifier 2 and read amplifier 4, guided to measuring circuit 5, and the various above-mentioned characteristics are measured. Measuring circuit 5 here may be either a dedicated circuit or one that utilizes an off-the-shelf measuring apparatus, such as an oscilloscope or spectrum analyzer.

The above is a conventional mainstream measuring method for a magnetic disk the recording surface of which is flat. For this measurement, a continuously outputted signal may be measured with little need to take data read timing into consideration. For example, since the TAA characteristic is the average amplitude for one rotation, a read timing of one rotation is required, but in most cases, a more desirable average value is obtained by reading continuous data of a plurality of rotations and calculating the average amplitude over a relatively long period of time.

However, in recent years, a discrete track style of magnetic disk, which provides grooves between recording tracks, has made its appearance. This is a magnetic disk, which strives to narrow track spacing and achieve higher recording density than in the past by providing grooves between recording tracks via a molding method or etching method, and reducing fringing and crosstalk. In a magnetic disk recording device (HDD), writing and reading are performed while the head follows the center of a track by tracking servo control. There are types of discrete track magnetic disks, for which a bump-shaped servo pattern for position detection is intermittently formed on recording tracks for this tracking servo control. This bumpy servo pattern is formed when a magnetic disk is manufactured using the same method as that to form the grooves. Further, this bumpy servo pattern must be converted to magnetic data capable of being read by a magnetic head. This is achieved by first magnetizing the convex and concave portions in a certain direction by applying a strong magnetic field from a head, and next reversing the magnetizing direction of the convex portions only by applying a weak reverse-direction magnetic field from the head.

To properly measure the read/write characteristics of a discrete track magnetic disk, an evaluation system may also implement read/write while following the center of a track with a head using tracking servo control the same as a magnetic disk recording device (HDD). But when the type of equipment targeted for evaluation changes, the head drive mechanism and servo pattern change, and it is extremely difficult to incorporate an all-purpose servo control function capable of evaluating diverse types of magnetic disks into an evaluation system. Diverse types of magnetic disks must be handled with an evaluation system, which does not comprise a tracking servo control function.

However, since tracks are determined for a discrete track magnetic disk when the disk is manufactured, when a disk is chucked to a spindle of an evaluation system to measure its characteristics, the disk rotates in an eccentric condition without the center of a concentric track aligning with the center of rotation of the spindle. The degree of eccentricity constitutes a value comprising both the amount of displacement between the center of a concentric track and the center of the circle of a disk inner diameter, and the amount of spindle chucking error, and ordinarily is several tens of micrometers. Meanwhile, because track spacing is around 1 micrometer, when the head position is fixed, it transverses several tens of tracks during a single rotation of the disk.

When read/write is performed while the head is traversing tracks and grooves like this, normal signal amplitude is achieved when the head is in the vicinity of the center of a track, but signal amplitude becomes smaller as the head drifts away from the center of the track. This situation is shown in FIG. 4. FIG. 4 is a waveform of a read signal observed via an oscilloscope, the horizontal axis representing time, and the vertical axis representing amplitude for which a peak value is normalized by ±1. The curved lines in the figure are read signal waveforms and their envelopes. The rate at which the head cuts across tracks will speed up and slow down according to the angle of rotation of a disk. Actually, the frequency of a read signal waveform and the frequency of its envelope differ more than 1000-fold, but for the sake of ease-of-understanding, the frequency of the read signal waveform shown in the figure has been lowered. The fact that the read/write characteristics of a read signal waveform such as this cannot be accurately measured and evaluated as-is is a problem.

Further, in the case of a discrete track magnetic disk such that the bumpy servo patterns on the recording tracks are formed with spaces therebetween also poses the problem of read/write characteristics being unable to be measured and evaluated accurately since signals in the servo pattern domain are intermittently intermixed with read signals. In addition, there is also demand for the ability to intentionally shift the head position little-by-little from the center of a track toward the outside perimeter or the inside perimeter, and to measure characteristics by making the amount of this displacement a parameter (measurement of off-track characteristics).

### SUMMARY OF THE INVENTION

In light of the above, it would be desirable to provide an evaluation system for magnetic disk medium for accurately measuring and evaluating read-write characteristics and off-track characteristics for a discrete track magnetic disk using an evaluation system, which does not comprise a tracking servo control function.

The present invention measures and evaluates read-write characteristics and off-track characteristics independently of a mechanism portion by only improving the signal processing portion of an evaluation system, which does not provide a tracking servo control function.

In a preferred embodiment the invention provides a magnetic disk medium evaluation system for evaluating the read/write characteristics of a magnetic disk medium on which grooves are provided between recording tracks, and is characterized in that it comprises amplifying means for amplifying a read signal read from a magnetic disk medium by a magnetic head; analog/digital converting means for converting a signal amplified by the above-mentioned amplifying means to a digital value; memory means for storing the output of the above-mentioned analog/digital converting means; on-track zone determining means for determining a zone in which a magnetic head is positioned in the proximity of the center of a track; and measuring means for measuring and evaluating characteristic values, and only data in the zone for which the above-mentioned on-track zone determining means has determined that the magnetic head is in the proximity of the center of a track, is selected from among the data stored in the above-mentioned memory means, and read/write characteristics is performed by the above-mentioned measuring means.

Preferably, the above-mentioned on-rack zone determining means makes a determination that it is an on-track zone when the amplitude of the envelope of a read signal waveform is greater than a prescribed value relative to a peak value.

In another preferred embodiment, the invention provides a magnetic disk medium evaluation system according to the invention of Claim 1, on which there are grooves between tracks and servo patterns are formed in a convexo-convex fashion for head positioning control, and which is characterized in that [it] comprises servo pattern demodulating means for detecting a servo pattern and calculating a head positioning error value from a track center based on a servo pattern read signal, and the above-mentioned on-track zone determining means determines that it is an on-track zone when a positioning error value is less than a prescribed value from the center of a track.

Preferably, the above-mentioned servo pattern demodulating means detects a servo pattern zone, and the above-mentioned measuring means evaluates read-write characteristics using data stored in the above-mentioned memory means, exclusive of the data in the zone which has been determined as a servo pattern zone.

Preferably, the above-mentioned on-track zone determining means determines that it is an on-track zone when the positioning error value detected by the above-mentioned servo pattern demodulating means is within a prescribed permissible range based on a value, which deviates from a track center by a specified off-track quantity.

### BRIEF OF THE DESCRIPTION DRAWINGS

The invention will now be described with reference to certain preferred embodiments thereof and the accompanying drawings, wherein:

FIG. 1 is a block diagram showing a simplified block diagram of a signal processing portion of a first embodiment of the present invention;

FIG. 2 is a block diagram showing a simplified block diagram of a signal processing portion of a second embodiment of the present invention;

FIG. 3 is a block diagram showing a simplified block diagram of a signal processing portion of a conventional evaluation system for a magnetic disk medium;

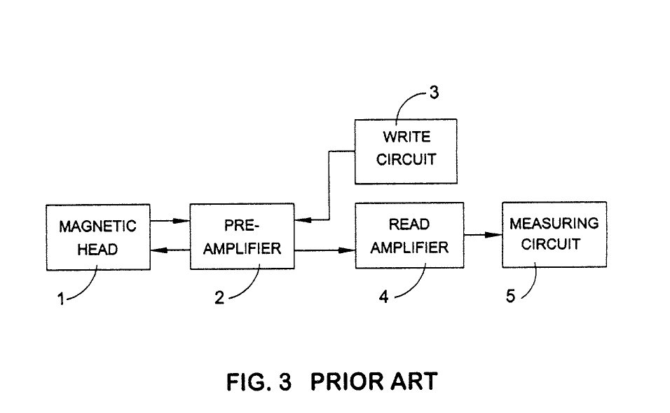

FIG. 4 is a read signal waveform for a discrete track system;

FIG. 5(a) is a waveform diagram of an envelope signal utilized in determining an ontrack zone, and (b) is a waveform diagram of on-track zone signals; and

FIG. 6 is an output signal of a servo pattern demodulating circuit of the second embodiment (position error value).

### DETAILED DESCRIPTION OF THE PREFERRED EMBODIMENTS

First Embodiment

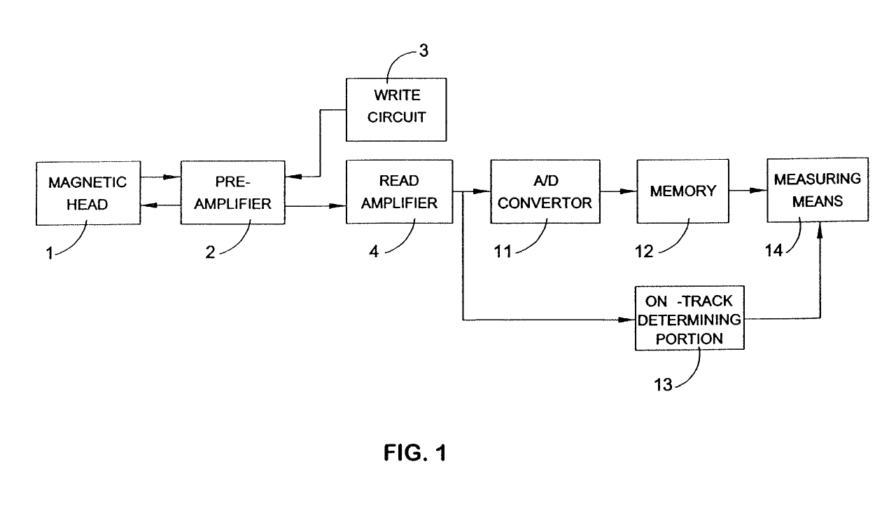

FIG. 1 shows a simplified block diagram of a signal processing portion of a first embodiment of the present invention for an evaluation system.

As in the above-mentioned conventional example, it is not shown in the figure, but the first embodiment has a disk driving portion for driving a magnetic disk in a rotating condition via a spindle motor in the evaluation system.

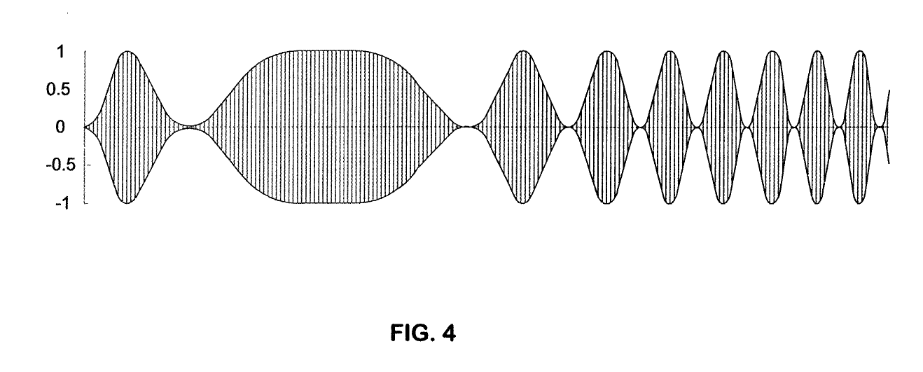

The parts, which write data from write circuit 3 via magnetic head 1 to a magnetic disk rotated by this disk driving portion, read this written data, and amplify a read signal of a continuous analog waveform from magnetic head 1 via preamplifier 2 and read amplifier 4, are exactly the same as the conventional example. The amplitude of this read signal waveform fluctuates greatly just as shown in FIG. 4.

This read signal is converted to a digital signal by an analog/digital converter (hereinafter referred to as an AID converter) 11, and is stored in memory 12. Here, the sampling frequency of A/D converter 11 is set at more than two times the frequency of a read signal, between 4- and 8-times or more if possible. A general-purpose digitizing oscilloscope may be used for the A/D converter 11 and memory 12. Further, it is preferable that memory 12 be capable of storing all of a single rotation's worth of read signals, but it need not necessarily be a large-capacity memory because split processing in appropriate angle of rotation units is also possible.

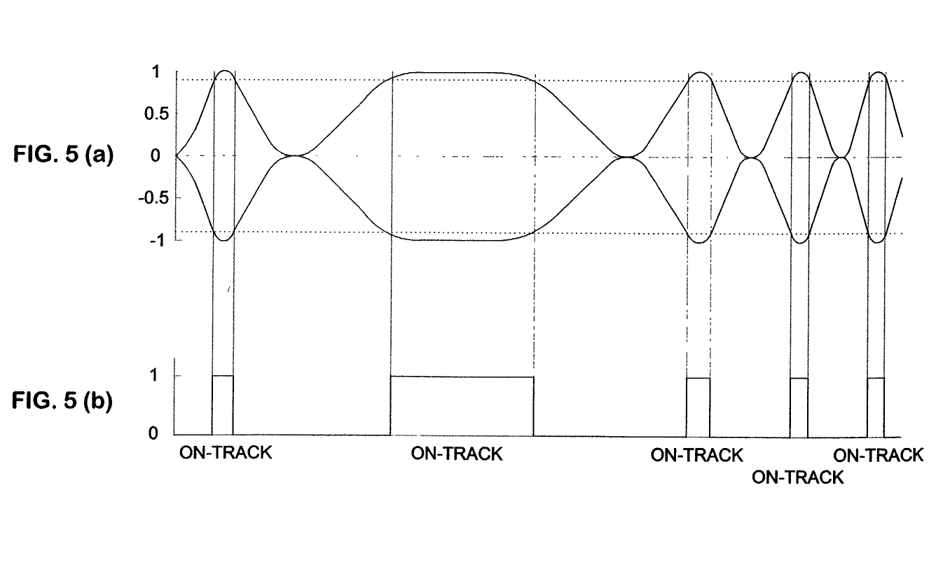

On-track determining portion 13 processes an output signal of read amplifier 4, detects that the magnetic head is positioned on the center portion of a magnetic disk track, i.e. is in a so-called on-track state, and generates an on-track zone signal OT. Based on the size of the amplitude of the envelope of a read signal waveform, this on-track determining portion performs normalization by treating the peak amplitude of the envelope as 1 as shown in FIG. 5, and outputs an on-track zone signal OT by treating the part of the amplitude in excess of 0.9, for example, as a zone, in which a normal read signal is obtained by an on-track state, that is, a state, wherein the head is positioned in the proximity of the center of a track (FIG. 5(b)).

An on-track determining portion 13 like this may use hardware circuit means for detecting this envelope from outputted analog signals of read amplifier 4 as shown in FIG. 5(a), and for acquiring on-track timing signals like those shown in FIG. 5(b) by using a comparator to compare the levels of this envelope. Further, this may also be replaced by software means for determining via a microprocessor the amplitude of read signals captured to memory 12, and generating timing signals for on-track zones. This microprocessor may also serve as the component utilized as a measuring means 14 described hereinbelow.

All of these means are the same in that they form on-track zone signals based on read signals acquired from magnetic head 1.

The measuring means 14 of FIG. 1 constitutes a microprocessor or a personal computer, and it selects and extracts from among the read signals inside the above-mentioned memory 12 only that signal waveform data determined to be on-track zones, measuring and evaluating this data as the target of a characteristics evaluation. For example, when measuring TAA characteristics, each peak value of the +side and −side, respectively, of the read signal waveforms of on-track zones may be calculated, and the average value of all of these absolute values may be determined. For SN ratio characteristics, SN ratios may be calculated for each on-track zone by analyzing frequencies via fast Fourier transform (FFT), and the average value of these ratios may be determined.

Similarly, the same accurate evaluation results as those for a disk of a conventional system may also be obtained for a disk of a discrete track system if other characteristic values are measured and evaluated using data in the on-track zone as well.

Second Embodiment

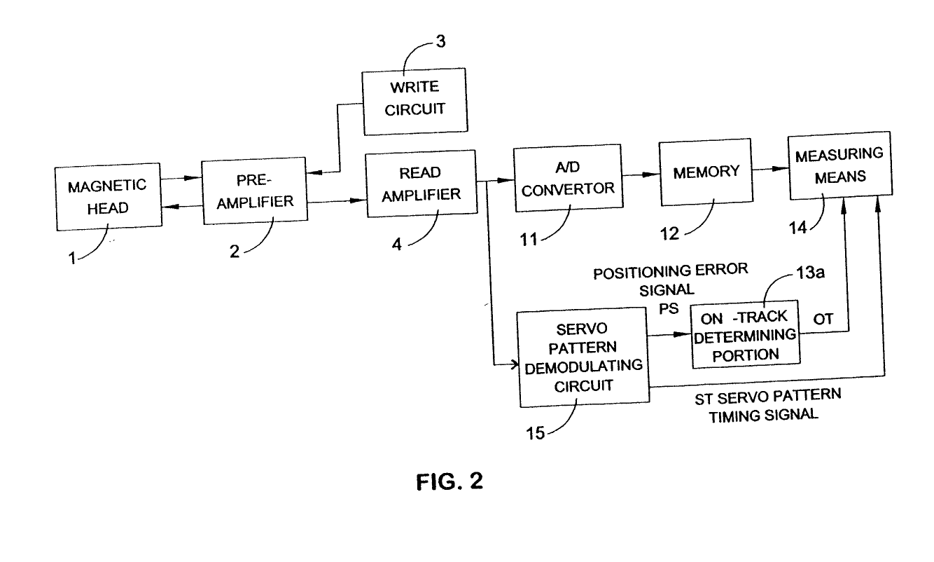

FIG. 2 shows another embodiment. The difference with the first embodiment lies in the method for determining an on-track zone. Further, this embodiment may only be applied to a magnetic disk of a discrete track system for which both servo patterns and grooves are formed.

In the first embodiment, an on-track zone was determined on the basis of the amplitude of the envelope of a read signal waveform, but in this second embodiment, a positioning error value PS, which indicates how far the position of the magnetic head is deviating from the center of a track, is determined from a read signal of a servo pattern recorded on a magnetic disk, and an on-track zone is calculated based on this error value.

Servo pattern demodulating circuit 15 in FIG. 2 calculates a positioning error value from the output signal of read amplifier 4. The input waveforms of servo pattern demodulating circuit 15 are complex due to the following factors: servo pattern information is recorded intermittently on a magnetic disk, the magnetic disk rotates eccentrically, and the head transverses several dozen tracks during a single rotation.

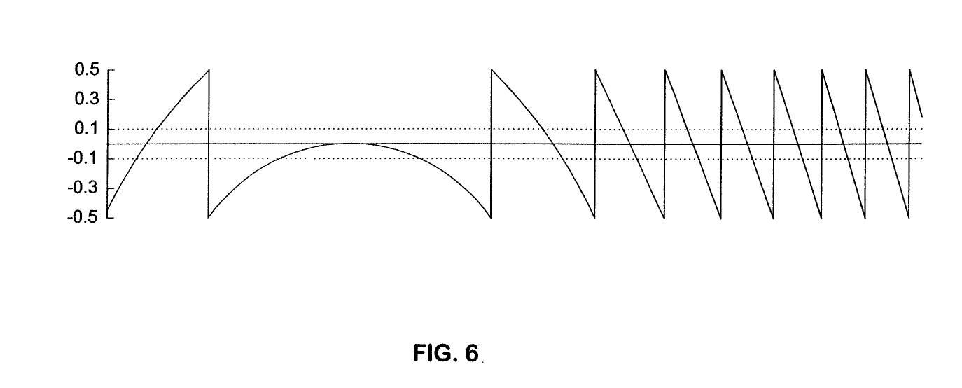

To explain the operation of demodulating circuit 15, if the read signal waveform of a servo pattern is a waveform such as that shown in FIG. 4, the results of calculating a positioning error value based on this waveform (output of demodulating circuit 15) become like FIG. 6.

In FIG. 6, the vertical axis is the amount of deviation of the magnetic head from the center of a track, and this deviation is indicated by a value, which performs normalization by treating track spacing as 1. The signs +, − indicate the direction of deviation, for example, + indicates the head is deviating to the outer perimeter side, and − indicates it is deviating to the inner perimeter side. A position for which this amount of deviation is near 0 is an on-track zone. Further, a place where the sign of a waveform reverses from +0.5 to −0.5 (or vice versa) signifies that the head has deviated from the outer perimeter side of a certain track to the inner perimeter side of an adjacent track (or vice versa). Furthermore, unlike FIG. 4, even if the head actually continues to be positioned on the same track, the servo pattern appears intermittently, and only an intermittent positioning error value that differs from FIG. 6 may be obtained, but a continuous positioning error value may be approximately obtained by interpolating the intervals thereof using straight lines or spline curves.

Based on positioning error value signals PS obtained as described hereinabove, if on-track determining portion 1 3a makes a determination that an area of within ±0.1, for example, is an on-track zone, and generates an on-track zone signal, read/write characteristics may be accurately evaluated if measurement processing is performed via the same measuring means 14 as the first embodiment.

Further, a servo pattern portion on a track of a magnetic disk is an area for which normal data recording and reproduction cannot be performed by the magnetic head because the surface is bumpy, and, when treated as computer external memory, constitutes an area that falls outside the data recording area. Therefore, it is not necessarily appropriate to use a read signal of this area in a measurement for a magnetic disk read/write evaluation. Thus, in this second embodiment, not only does servo pattern demodulating circuit 15 determine a positioning error signal PS for a read signal outputted from read amplifier 4, it also reads a servo pattern timing signal, and assigns this timing signal to measuring means 14, and this measuring means 14 carries out processing, which excludes data of a servo pattern signal-assigned period from a measurement, for example, even if it is an on-track zone.

The measurement described hereinabove is a normal characteristics measurement of when the head is positioned in the center of a track (when it is on-track), but, in addition, when the position of the head is purposely deviated from the center of a track, there is a measurement of off-rack characteristics for measuring characteristics by treating the amount of this deviation as a parameter.

In the method of the first embodiment, it is possible to infer a zone in the proximity of the center of a track, but as explained hereinabove, the speed at which the head transverses tracks due to eccentricity changes greatly depending on the angle of rotation position, and changes in the amplitude of read signal waveforms are irregular and complex, making the inference of the amount of deviation by interpolation really quite difficult. Thus, the method of the first embodiment cannot be applied to the measuring of off-track characteristics.

Conversely, according to the method of the second embodiment, servo pattern signals, while intermittent, are well-defined signal waveforms, and since the interpolated inference error of the amount of deviation of adjacent on-track intermediate areas is smaller than in the first embodiment, the practical and complete measurement of off-track characteristics is possible. In the case of normal on-track characteristics measurement, whereas measurements were performed using data of within a zone, in which the amount of deviation from the center of a track, for example, was ±0.1 tracks or less (hereinafter expressed as 0±0.1), the measurement of off-track characteristics may be achieved by changing the central value, such as 0±0.02, 0.05±0.02, 0.1±0.02, selecting only read signal waveforms that correspond to the respective ranges as the targets of computation, and calculating characteristic values, such as average amplitude characteristics (TAA).

According to the present invention, since a magnetic disk medium evaluation system for evaluating the read/write characteristics of a magnetic disk medium, which is provided with grooves between recording tracks, comprises amplifying means for amplifying a read signal read from a magnetic disk medium by a magnetic head; analog/digital converting means for converting a signal amplified by the above-mentioned amplifying means to a digital value; memory means for storing the output of the above-mentioned analog/digital converting means; on-track zone determining means for determining a zone in which a magnetic head is positioned in the proximity of the center of a track; and measuring means for measuring and evaluating characteristic values, and only data in the zone for which the above-mentioned on-track zone determining means has determined that the magnetic head is in the proximity of the center of a track, is selected from among the data stored in the above-mentioned memory means, and the evaluation of read/write characteristics is performed by the above-mentioned measuring means, there is the effect that the evaluation system does not comprise a tracking servo control function, and on-track read/write characteristics may be measured and evaluated for discrete track system magnetic disks.

Further, in the above-mentioned magnetic disk medium evaluation system, an evaluation system for a magnetic disk medium, on which there are grooves between tracks and servo patterns are formed in a convexo-convex fashion for head positioning control, comprises servo pattern demodulating means for detecting a servo pattern and calculating a head positioning error value from a track center based on a servo pattern read signal, and when the above-mentioned on-track zone determining means determines that it is an on-track zone when a positioning error value is less than a prescribed value from the center of a track, not only on-track read/write characteristics, but also off-track read/write characteristics may be accurately measured and evaluated.

What is claimed is:

1. A magnetic disk medium evaluation system for evaluating the read/write characteristics of a magnetic disk medium, which is provided with grooves between recording tracks, comprising:
amplifying means for amplifying a read signal read from a magnetic disk medium by a magnetic head;
analog/digital converting means for converting a signal amplified by said amplifying means to a digital value;
memory means for storing the output of said analog/digital converting means;
on-track zone determining means for determining a zone in which the magnetic head is positioned in the proximity of the center of a track; and
measuring means for measuring and evaluating characteristic values,
wherein only data in the zone, for which said on-track zone determining means has determined that the magnetic head is in the proximity of the center of a track, is selected from among the data stored in said memory means, and read/write characteristics are evaluated by said measuring means.

2. The magnetic disk medium evaluation system according to claim 1, wherein, when the amplitude of the envelope of a read signal waveform relative to a peak value is greater than a prescribed value, said on-track zone determining means determines that such zone is an on-track zone.

3. The magnetic disk medium evaluation system according to claim 1, said evaluation system being for a magnetic disk medium, on which in addition to grooves formed between tracks, servo patterns are formed in a convexo-convex fashion for the control of head positioning, and comprising servo pattern demodulating means for detecting a servo pattern and calculating a head positioning error value from a track center based on a servo pattern read signal, wherein when a positioning error value is less than a prescribed value from the center of a track, said on-track zone determining means determines that such track is an on-track zone.

4. The magnetic disk medium evaluation system according to claim 3, wherein said servo pattern demodulating means detects a servo pattern zone, and said measuring means evaluates read-write characteristics using data stored in said memory means, exclusive of the data in the zone that has been determined as a servo pattern zone.

5. The magnetic disk medium evaluation system according to claim 3, wherein when the positioning error value detected by said servo pattern demodulating means is within a prescribed permissible range based on a value which deviates from a track center by a specified off-track quantity, said on-track zone determining means determines that such track is an on-track zone.

6. A magnetic disk medium evaluation system for evaluating the read/write characteristics of a magnetic disk medium, which is provided with grooves between recording tracks, comprising:
amplifying a read signal read from a magnetic disk medium by a magnetic head;
converting the amplified read signal to a digital read signal;
storing the digital read signal;
determining a zone in which the magnetic head is positioned in the proximity of the center of a track; and
measuring and evaluating read/write characteristic values,
wherein only data in the zone, for which the system has determined that the magnetic head is in the proximity of the center of a track, is selected from among the stored data, and read/write characteristic values are evaluated.

7. The magnetic disk medium evaluation system according to claim 6, wherein, when the amplitude of the envelope of a read signal waveform relative to a peak value is greater than a prescribed value, the system determines that such zone is an on-track zone.

8. The magnetic disk medium evaluation system according to claim 6, said evaluation system being for a magnetic disk medium, on which in addition to grooves formed between tracks, servo patterns are formed in a convexo-convex fashion for the control of head positioning, further comprising:
detecting a servo pattern and calculating a head positioning error value from a track center based on a servo pattern read signal, wherein when a positioning error value is less than a prescribed value from the center of a track, the system determines that such track is an on-track zone.

9. The magnetic disk medium evaluation system according to claim 8, wherein a servo pattern zone is detected, and read-write characteristics are evaluated using stored data, exclusive of the data in the zone that has been determined as a servo pattern zone.

10. The magnetic disk medium evaluation system according to claim 8, wherein when the positioning error value is within a prescribed permissible range based on a value which deviates from a track center by a specified off-track quantity, the system determines that such track is an on-track zone.
